(19) United States
(12) Patent Application Publication
(10) Pub. No.: US 2009/0049417 A1
(43) Pub. Date: Feb. 19, 2009

(54) METHOD OF DESIGNING A CIRCUIT FOR OPTIMIZING OUTPUT BIT LENGTH AND INTEGRATED CIRCUIT THEREFOR

(75) Inventors: Shuuetsu KINOSHITA, Tokyo (JP); Kenichi SHINDATE, Tokyo (JP); Keitaro ISHIDA, Gunma (JP)

Correspondence Address: Studebaker & Brackett PC, 1890 Preston White Drive, Suite 105, Reston, VA, 20191, US

(73) Assignee: OKI ELECTRIC INDUSTRY CO., LTD., Tokyo (JP)

(21) Appl. No.: 12/189,408

(22) Filed: Aug. 11, 2008

(30) Foreign Application Priority Data
Aug. 17, 2007 (JP) 2007-212832

(51) Int. Cl. G06F 17/50

(52) U.S. Cl. 716/5; 716/18

(57) ABSTRACT

In a circuit designing method for arithmetic elements to be employed in digital signal processing, a program is produced so that a directive is added to a target arithmetic operation which provides an overflow determination about desired digital signal processing. On the basis of this program, behavioral synthesis is performed. By adding an overflow detector to the target arithmetic operation, an RTL-description circuit is produced. The operation verification of the RTL-description circuit is performed to obtain the detection results of the overflow detector. When the RTL-description circuit is again produced on the basis of the operation verification results, the output bit length of the target arithmetic operation is optimized on the basis of the overflow detection results so that overflow is suppressed, whereby an optimized RTL-description circuit can be produced.

### BACKGROUND OF THE INVENTION

1. Field of the Invention

The present invention relates to a method of designing a circuit for arithmetic elements that are employed in digital signal processing, and also to an integrated circuit fabricated by that method.

2. Description of the Background Art

Conventionally, in circuit designing methods, when describing a circuit with a hardware description language (HDL), a behavioral synthesis tool has been employed to describe the operation of a circuit at register transfer level (RTL), on the basis of a software program for implementing predetermined functions. For example, the behavioral synthesis tool can perform behavioral synthesis of program sequences defining moving-picture compression steps, such as the MPEG (Moving Picture Experts Group) standard operating on personal computers (PCs), to produce RTL description in a short time interval.

In the case where digital signal processing such as moving-picture compression is performed with a software program, such a behavioral synthesis tool usually handles data in the units of 8 bits, 16 bits, 32 bits, or 64 bits, but often handles data of bits differing in number from the actually required bits. Therefore, if such a software program is operation-synthesized as it is, a large number of arithmetic elements with a longer bit width than necessary will be produced and consequently the circuit scale will be increased.

Because of this, in the conventional circuit designing methods, the range of input data for individual arithmetic operations was examined beforehand to determine the minimum number of bits required, and behavioral synthesis was executed with the minimum number of bits.

For example, in a conventional flow of designing a circuit, the bit length of each arithmetic element is first decided on the basis of a software program defining desired circuit design. Then, on the basis of the software program and decided bit length, behavioral synthesis is performed to produce an RTL-description circuit. Next, the produced RTL-description circuit is verified as to whether or not to operate normally, and the bit length of each arithmetic element is optimized based on the operation verification results. The behavioral synthesis is again performed on the basis of the software program and optimized bit length, whereby the optimal RTL-description circuit can be produced.

A method of converting logic synthesis description disclosed in Japanese patent laid-open publication No. 301741/1994 aims at, with regard to the HDL-description design at functional and logic level, designing large-scale integration (LSI) circuits of high quality easily without resorting to technical experts. In the method, a description of a multiplication of constants and variables is replaced with another description having an addition and a shift operation. In addition, an assignment-statement analyzer in the method compares the bit widths of the left-hand side and the right-hand side of an assignment statement. As a result of the comparison, when they differ from each other, the smaller of the two bit widths is widened to substitute a zero value into the widened portion.

In the conventional circuit designing method, however, if the software programs are operation-synthesized as they are, a redundant circuit will be produced and result in an increase in circuit scale and power consumption. In the case where circuits fabricated by such a method are commercialized, it is necessary to achieve circuit minimization and low power consumption. For instance, the output bit length of an arithmetic element is optimally determined corresponding to the input data range of the arithmetic element so that the circuit operates at high speed.

Since digital signal processing such as moving-picture compression performs a vast number of arithmetic operations, the conventional circuit designing method requires a considerable amount of time when examining an output bit length and determining an optimal bit length for all arithmetic operations. In addition, if there is not a good knowledge of algorithms for digital signal processing, an erroneous bit length is often determined. Besides, the verification of a circuit thus using a vast number of arithmetic operations requires an enormous amount of time. Moreover, when a particular arithmetic operation overflows, it is fairly difficult to find that overflowing location.

In the context, the term “overflow” means that a calculated value exceeds the maximum of a numerical value that can be handled.

Therefore, the conventional circuit designing method lessens the advantageous effect that the use of the behavioral synthesis tool allows design to be performed in a short time interval.

### SUMMARY OF THE INVENTION

It is an object of the present invention to provide a method of designing a circuit that is capable of designing a minimum circuit without causing each arithmetic element to overflow, and efficiently performing the operation verification of the circuit. It is another object of the invention to provide an integrated circuit fabricated by that method.

In accordance with the present invention, there is provided a method for designing a circuit having arithmetic elements that are employed in digital signal processing. The method includes a program production step of producing a program sequence defining desired digital signal processing; a addition step of adding a directive to target one of a plurality of arithmetic operations, contained in the program sequence, the target arithmetic operation providing an overflow determination of an arithmetic operation result; a decision step of an output bit length of each of the arithmetic operations; a circuit production step of performing behavioral synthesis on the basis of the program sequence and the output bit length, describing at register transfer level (RTL) a circuit for implementing the desired digital signal processing, then producing an RTL-description circuit so that a detector for detecting information about the output bit length is added to the circuit in correspondence with the target arithmetic operation; and a verification step of performing operation verification of the RTL-description circuit to obtain a detection result of the detector as a result of the operation verification. After the verification step, when it is determined on the basis of the operation verification result that the RTL-description circuit should be optimized, the bit length deciding step and the circuit production step are repeated. When the circuit production step produces the RTL-description circuit for the first time, the decision step decides a predetermined initial value as the output bit length, and when the circuit production step produces the RTL-description circuit in a second loop and a subsequent loop, the decision step decides an output bit length of each of the arithmetic operations by optimizing the output bit length on the basis of a detection result about the RTL-description circuit produced last.

In accordance with the present invention, there is provided an integrated circuit which is designed by a circuit designing flow for producing an RTL-description circuit on the basis of a program sequence defining desired digital signal processing, and which is fabricated by employing the optimized RTL-description circuit. In the circuit designing flow, when using the program sequence in which a directive is added to target one of a plurality of arithmetic operations contained in the program sequence, the target arithmetic operation providing an overflow determination of an arithmetic operation result and performing behavioral synthesis on the basis of at least the program sequence to describe at register transfer level (RTL) a circuit for implementing the desired digital signal processing, the RTL-description circuit is produced so that the target arithmetic operation is added to a detector for detecting information about the output bit length. When operation verification of the RTL-description circuit is performed to obtain a detection result of the detector as a result of the operation verification, and it is determined on the basis of the operation verification result that the RTL-description circuit should be optimized, the RTL-description circuit is again produced so that the output bit length of the target arithmetical operation is optimized on the basis of the detection result. The optimized RTL-description circuit is obtained by repetitively producing the RTL-description circuit until the output bit length of each of the arithmetic operations is optimized.

In accordance with the present invention, there is provided a behavioral synthesis tool for producing an RTL-description circuit by performing behavioral synthesis on the basis of a program sequence defining desired digital signal processing. In the synthesis tool, the program sequence is input in which a directive is added to target one of a plurality of arithmetic operations contained in the program sequence, the target arithmetic operation providing an overflow determination of an arithmetic operation result. The synthesis tool includes a decider for deciding an output bit length of each of the arithmetic operations; and an circuit producer for describing a circuit for implementing the desired digital signal processing on the basis of the program sequence and the output bit length at register transfer level, then adding to the target arithmetic operation a detector for detecting information about the output bit length, and thereby producing the RTL-description circuit. After an operation verification result of the RTL-description circuit is obtained, when it is determined on the basis of the operation verification result that the RTL-description circuit should be optimized, the decider and the circuit producer are executed again. When the circuit producer produces the RTL-description circuit for the first time, the decider decides a predetermined initial value as the output bit length, and when the circuit producer produces the RTL-description circuit in a second loop and a subsequent loop, the decider obtains, as the operation verification result, a detection result of the detector of the RTL-description circuit produced last, and decides an output bit length of each of the arithmetic operations by optimizing the output bit length on the basis of the detection result.

According to the method of designing a circuit of the present invention, when producing a program sequence implementing desired digital signal processing, a directive is added to target one of a plurality of arithmetic operations, which desires an overflow determination of an arithmetic operation result. In producing an RTL-description circuit on the basis of the program sequence, an overflow detector is added to the target arithmetic operation. When the operation verification of the RTL-description circuit thus produced is performed, the detection result of the overflow detector can be obtained. Therefore, the location of the occurrence of overflow can be easily found. In addition, by examining whether or not the overflow is occurred, it is possible to know whether or not the output bit width of each of the arithmetic operations is sufficient.

In the circuit designing method of the present invention, when producing the RTL-description circuit again on the basis of the operation verification result, the output bit length of the target arithmetic operation can be optimized based on the overflow detection result. Therefore, the minimum circuit can be designed without causing each arithmetic operation to overflow, and the operation verification of the circuit can be efficiently performed.

Moreover, in the circuit designing method of the present invention, by writing the RTL-description circuit into a programmable logic circuit such as a Field Programmable Gate Array (FPGA), the operation verification can be performed at high speed. Therefore, verification for detecting a data width needed for each arithmetic operation can be efficiently performed. In addition, the method can be employed in verifying a large amount of data.

Furthermore, in the circuit designing method of the present invention, if an operation verification result is obtained when each arithmetic operation is performed without overflow, the RTL-description circuit may be produced without adding the directive to the program sequence. Therefore, an integrated circuit can be fabricated on the basis of the RTL-description circuit without containing an extra overflow detector.

### BRIEF DESCRIPTION OF THE DRAWINGS

The objects and features of the present invention will become more apparent from consideration of the following detailed description taken in conjunction with the accompanying drawings in which:

FIG. 1 is a flowchart useful for understanding how an embodiment of the circuit designing method of the present invention operates;

FIG. 2 is a schematic block diagram showing a configuration for implementing the designing method shown in FIG. 1;

FIG. 3 shows an exemplified program sequence containing an overflow detecting directive in accordance with the designing method shown in FIG. 1;

FIG. 4 is a schematic block diagram showing an RTL-description circuit produced to contain an overflow detector in accordance with the designing method shown in FIG. 1;

FIG. 5 is a schematic block diagram showing the output data register and overflow detector shown in FIG. 4;

FIG. 6 shows the overflow detection results for the different register's values in the embodiment shown in FIG. 5;

FIG. 7 is a flowchart, like FIG. 1, useful for understanding how an alternative embodiment of the circuit designing method of the present invention operates;

FIG. 8 shows, like FIG. 3, an exemplified program sequence containing a bit width detecting directive in accordance with the method shown in FIG. 7;

FIG. 9 is a schematic block diagram, like FIG. 4, showing an RTL-description circuit produced to contain a bit width detector in accordance with the method shown in FIG. 7;

FIG. 10 is a schematic block diagram, like FIG. 5, showing the output data register and bit width detector of FIG. 9; and

FIG. 11 shows the overflow detection results for the different register's values in the embodiment shown in FIG. 10.

### DESCRIPTION OF THE PREFERRED EMBODIMENTS

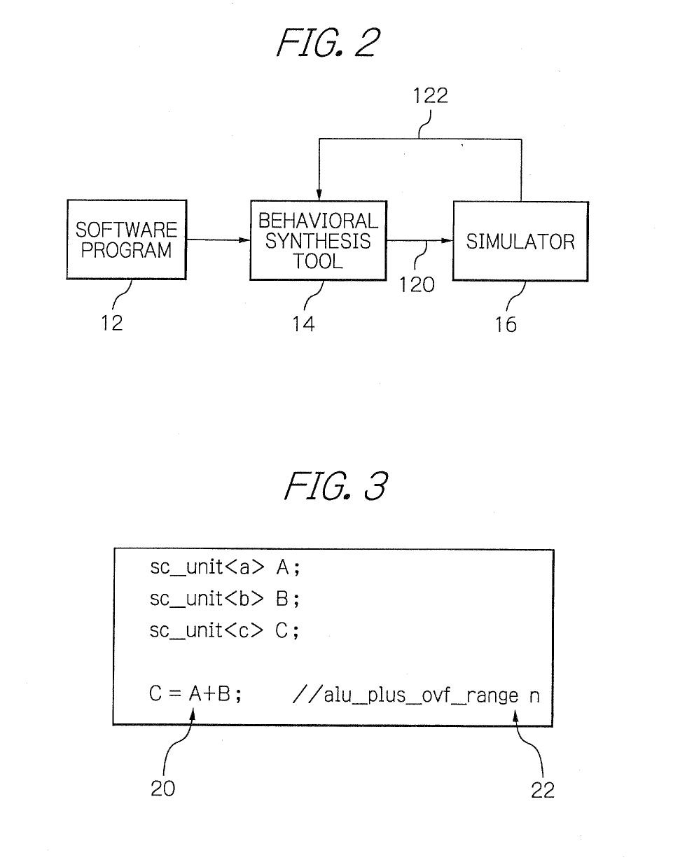

An illustrative embodiment of the method of designing a circuit in accordance with the present invention will hereinafter be described in detail with reference to the accompanying drawings. According to the method, as shown in FIG. 2, on the basis of a software program 12 for implementing a desired function, a behavioral synthesis tool 14 describes at the register transfer level (RTL) a circuit for actualizing the desired function. The RTL-description circuit is operation-verified by a simulator 16. Then, the behavioral synthesis tool 14 reproduces the RTL-description circuit by optimizing the bit width of each arithmetic element on the basis of the verification results. Particularly, in the present invention, the behavioral synthesis tool 14 adds an overflow detector to the produced RTL-description circuit, the operation verification results by the simulator 16 are obtained as overflow information, and the behavioral synthesis tool 14 optimizes the bit width of each arithmetic element on the basis of the overflow information. Note that parts or elements which are not directly relevant for understanding the present invention will not be shown for avoiding redundancy.

The software program 12 is a program sequence describing or defining intended digital signal processing. A typical example is a program on a moving-picture compression technique such as the MPEG standard that operates on personal computers (PCs). This software program 12, for example, may be produced on a PC by a designer and stored in a built-in storage medium such as a hard disk or memory, or a removable storage medium such as a floppy or optical disk.

The software program 12 contains a great number of instructions on arithmetic operations concerned with digital signal processing. Particularly, in the present invention, the program 12 is formed so that a directive is added to a particular arithmetic operation whose overflow is to be determined. For example, as shown in FIG. 3, in the program 12, as a directive 22, “//alu_plus_ovf_range n” is added to an arithmetic operation 20 whose overflow should be determined. In FIG. 3, while the program 12 contains only an addition, it is not limited to this, but may contain a wide variety of arithmetic operations.

The behavioral synthesis tool 14 is adapted to describe the circuit at the RTL on the basis of the software program 12 that is an object of designing an circuit. The behavioral synthesis tool 14 executes behavioral synthesis on the digital signal processing represented by the program 12 to produce an RTL-description circuit 120. The behavioral synthesis tool 14 may be constituted by software such as an application operating on a PC, and may store the produced RTL-description circuit 120 in the built-in storage medium of a PC, or a removable storage medium such as a floppy disk.

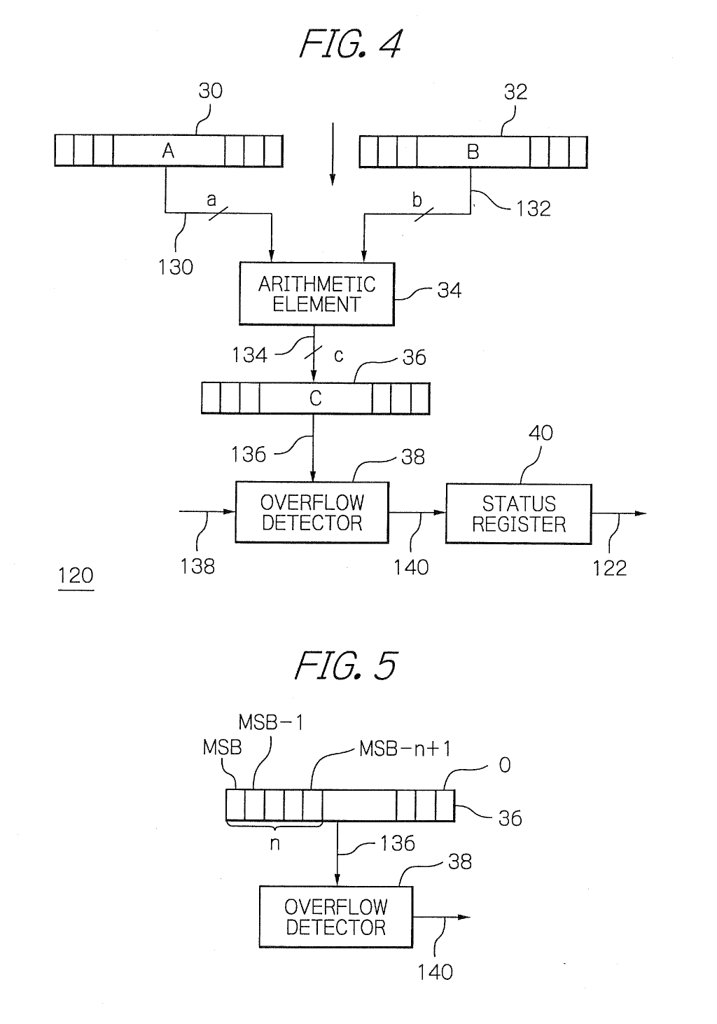

This behavioral synthesis tool 14 produces, for example the RTL-description circuit 120 as shown in FIG. 4 on the basis of the program 12 as shown in FIG. 3. Particularly, in the present invention, if the program 12 has a target arithmetic operation 20 adding the directive 22, the behavioral synthesis tool 14 produces the circuit 120 so that the circuit 120 is provided with an overflow detector 38 corresponding to the target arithmetic operation 20. In addition, the tool 14 may produce the circuit 120 so that the circuit 120 is provided with a status register 40 that stores overflow information 140 which is the detection results of the overflow detector 38.

The overflow detector 38 corresponding to the directive 22 is adapted to detect whether or not the overflow is occurred, on the basis of the value of the output data register 36 of a target arithmetic element 34. The detector 38 stores in the status register 40 the overflow information 140 representative of the detection results of the overflow. For example, if higher-order, or more significant, n bits are set as an overflow range 138, where n is a natural number, the overflow detector 38 to detect overflow by deciding the more significant n bits of the output data register 36.

The status register 40 corresponding to the directive 22 is adapted to hold the overflow information 140 obtained by the overflow detector 30. The status register 40 is also adapted to hold an identification number for identifying the target arithmetic element 34.

The behavioral synthesis tool 14 also optimizes the bit width of the target arithmetic operation 20 on the basis of the operation verification results 122 of the simulator 16, particularly the overflow information 140. When operation verification is not performed yet by the simulator 16, i.e. in the case of the first behavioral synthesis, the behavioral synthesis 14 may set a predetermined initial value as the bit width of the target arithmetic operation 20.

The simulator 16 is adapted to perform the operation verification of the RTL-description circuit 120 produced by the behavioral synthesis tool 14. The simulator 16, for example, may be constituted by software operating on PCs, such as a circuit simulator for verifying the RTL-description circuit 120, and may store the operation verification results 122 in the built-in storage medium of a PC, or a removable storage medium such as a floppy disk.

The simulator 16 of the illustrative embodiment may decide the operation verification results 122 by employing the overflow information 140 of the status register 40 produced in correspondence with the directive 22.

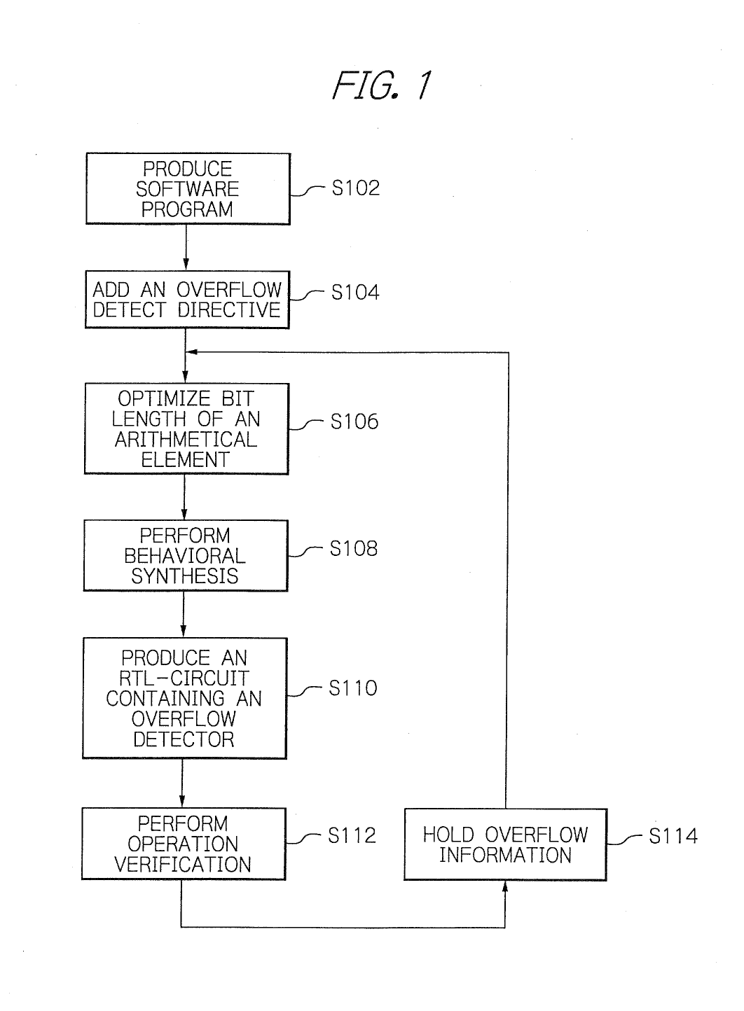

Now, the circuit designing operation of the illustrative embodiment will be described with reference to a flowchart shown in FIG. 1, taking an example of optimizing the output bit length of an arithmetic element by the detection of overflow.

In the illustrative embodiment, first, a user such as a circuit designer writes a software program 12 for digital signal processing that is an object of designing an circuit (S102), and particularly adds a directive 22 beforehand for an arithmetic operation to which an overflow detecting function is added (S104).

For instance, as shown in FIG. 3, in the case where the target arithmetic operation 20 whose overflow is to be determined calculates an expression “C=A+B”, and more significant n bits of the arithmetic operation results are utilized as the overflow range 138, a code “//alu_plus_ovf_range n” is added as the directive 22 to the target arithmetic operation 20. In FIG. 3, the initial values of the bit lengths of the input values A and B of the target arithmetic operation 20 are respectively indicated by marks of a and b and the initial value of the bit length of the output value C is indicated by marks of c.

Next, the user initiates the behavioral synthesis of the software program 12 with the behavioral synthesis tool 14.

In the behavioral synthesis tool 14, the output bit length of an arithmetic element is optimized for each arithmetic operation contained in the program 12 (S106). In this first behavioral synthesis, since the operation verification results 122 have not been obtained, the output of each arithmetic element is set at a predetermined initial or default bit length.

In the behavioral synthesis tool 14, behavioral synthesis is executed on the basis of the software program 12 (S108), and an RTL-description circuit 120 is produced by employing the bit length determined in step S106 so as to be provided with arithmetic elements corresponding to arithmetic operations in the program 12 (S110).

For example, the RTL-description circuit 120 on the basis of the program 12 as shown in FIG. 3 is constituted by input data registers 30 and 32 in which input values A and B are stored, an arithmetic element 34 having the function of the target arithmetic operation 20, and an output data register 36 in which an output value C is stored, as shown in FIG. 4.

Particularly, when the directive 22 is read from the program 12, in correspondence with the target arithmetic operation 20 to which the directive 22 was added, the overflow detector 38 and status register 40 are added to the circuit 120. For example, as shown in FIG. 4, the overflow detector 38 and status register 40 are connected to the register 36 that holds the arithmetic operation results of the target arithmetic element 34. Thus, the RTL-description circuit 120 is produced.

Furthermore, the user employs the simulator 16 to execute the operation verification of the RTL-description circuit 120 produced with the behavioral synthesis tool 14 (S112).

In this operation verification, the overflow detector 38 produced in correspondence with the directive 22 in the RTL-description circuit 120 detects whether or not the value of the output data register 36 of the target arithmetic element 34 overflows, and stores in the status register 40 the overflow information 140 representing the detection results of the overflow.

For example, if n bits are set as the overflow range 138, the overflow detector 38 determines the overflow by deciding the more significant n bits of the output data register 36. In the illustrative embodiment, as shown in FIG. 5, the most significant bit of the register 36 is denoted by “MSB”, the second most significant bit by “MSB-1”, and the least significant bit by “0”.

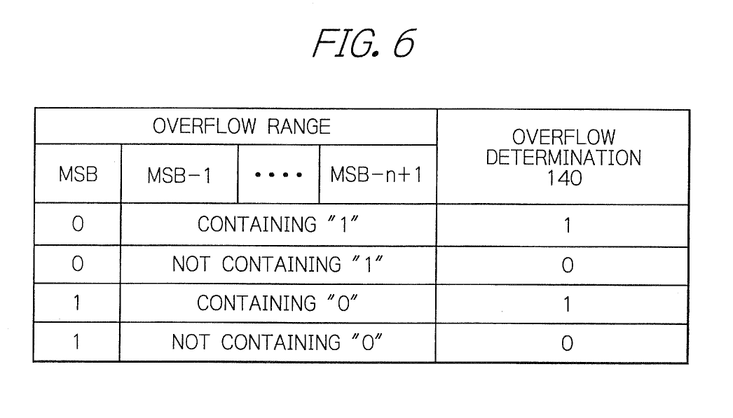

In this case, as shown in FIG. 6, when the value of the most significant bit MSB of the register 36 is binary “0”, i.e. when the register 36 indicates a positive value, the overflow detector 38 determines, in the case where any one of the values of the bits (MSB-1) to (MSB-n+1) has binary “1”, that the overflow has occurs, and, otherwise, determines that the overflow does not occur. The detector 38 stores these determination results in the status register 40 as the overflow information 140.

Similarly, when the value of the most significant bit MSB of the register 36 is “1”, i.e. when the register 36 indicates a negative value, the overflow detector 38 determines, in the case where any of the values of the bits (MSB-1) to (MSB-n+1) has binary “0”, that the overflow has occurred, and, otherwise, determines that no overflow occurs. The detector 38 also stores these determination results in the status register 40 as the overflow information 140.

Thus, the user is able to produce and hold the operation verification results 122 such as the overflow information 140 of the RTL-description circuit 120 obtained by the simulator 16 (S114).

When the overflow information 140 of the operation verification results 122 obtained in step S114 indicates that the overflow has occurred, the user returns to step S106 and is able to use the verification results 122 to again perform the behavioral synthesis of the software program 12 with the behavioral synthesis tool 14.

At this stage, in the behavioral synthesis tool 14, the bit length of the output of each arithmetic element is optimized (S106), and, particularly on the basis of the overflow information 140, the output bit length of the arithmetic element 34 that has overflowed can be enlarged.

For example, when the overflow information 140 indicates the occurrence of the overflow, the behavioral synthesis tool 14 updates the bit length of the output data register 36 of the target arithmetic element 34 to a value equal to the current bit length plus one-bit length.

In this manner, the user repeats steps S106 to S114 until the operation verification results 122 are obtained without overflow, and then terminates such a flow of designing the circuit. Because the RTL-description circuit 120 obtained at that termination time is constituted by arithmetic elements that do not overflow, the user is able to obtain the optimized RTL-description circuit 120. In addition, the user, if removing the directive 22 from the software program 12, is able to produce a final circuit without adding an extra overflow detector.

In the illustrative embodiment, the simulator 16 may perform the operation verification by a programmable logic circuit such as FPGA (Field Programmable Gate Array). In this case, the user writes into a programmable logic circuit the RTL-description circuit 120 produced with the behavioral synthesis tool 14. Moreover, the user connects this logic circuit to a simulating unit such as a PC having the simulator 16, and connects the status register 40 corresponding to the directive 22 to a data bus common with the CPU of this unit or a connecting line that is observable externally. Thus, the user is able to acquire the overflow information 140 of the status register 40 and employ the information in the reproduction of the RTL-description circuit 120.

The behavioral synthesis tool 14 can also produce an RTL-description circuit 120 so that an interrupt signal is output from the status register 40 corresponding to the directive 22. At this time, the user writes this RTL-description circuit 120 into a programmable logic circuit and connects the output of the status register 40 to the CPU of the simulator 16, thereby being able to acquire the overflow information 140 of the status register 40.

In the above illustrative embodiment, the behavioral synthesis tool 14 uses the overflow information 140 of the overflow detector 38 corresponding to the directive 22 to optimize the bit width of the target arithmetic element 34. Furthermore, in the alternative embodiment, the behavioral synthesis tool 14 may use the overflow information of an overflow detector incorporated regardless of the directive 22 into the software program 12 (i.e. an overflow detector described as a portion of an arithmetic element) to optimize the bit width of an arithmetic element corresponding to that overflow detector.

The behavioral synthesis tool 14 may also use the debugging function of software to obtain overflow information, instead of producing the status register 40. In this case, the overflow information is standard-output as the operation verification results obtained in simulation, whereby the output can be employed in the optimization of the bit width of an arithmetic element.

In the circuit designing method of the present invention, the behavioral synthesis tool 14 can produce an RTL-description circuit having a bit width detector to obtain bit width information as the operation verification results of the simulator 16, thereby optimizing the bit width of each arithmetic element on the basis of this bit width information.

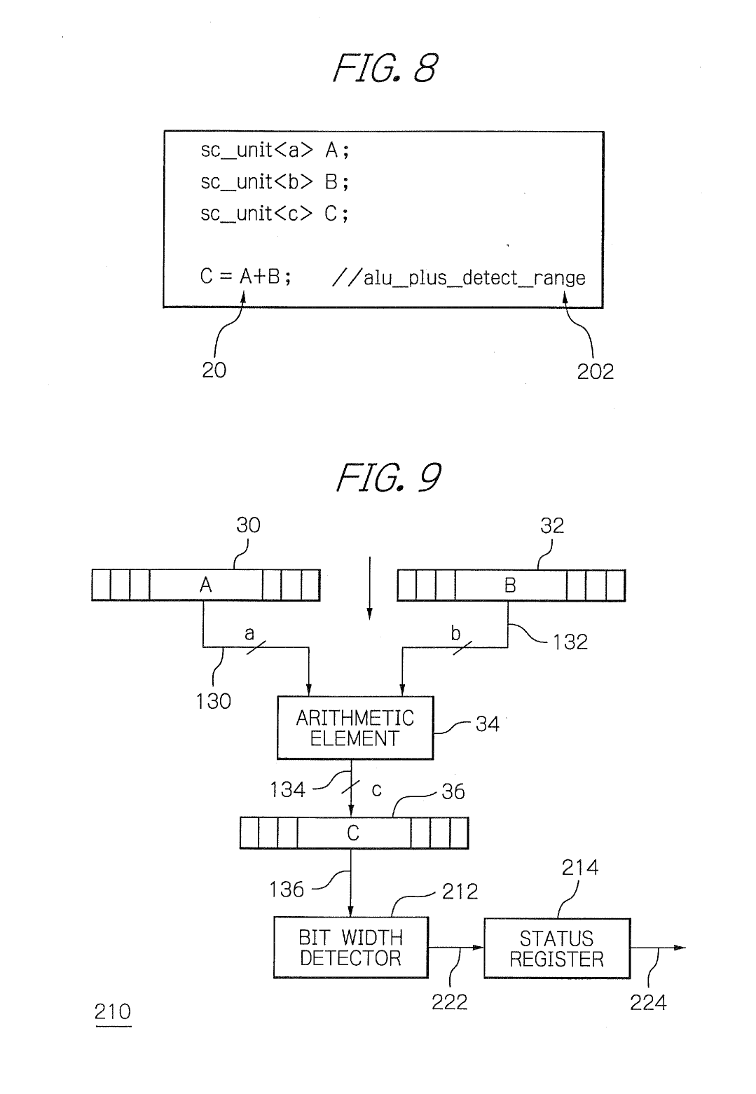

In this method, the software program 12 is formed to add a directive to an arithmetic operation whose bit width is to be determined. For example, as shown in FIG. 8, in the program 12, for an arithmetic operation 20 whose bit width is to be determined, a code “//alu_plus_detect_range” is described as a directive 202. In FIG. 8, while the program 12 contains only an addition, it is not limited to this, but may contain a wide variety of arithmetic operations.

The behavioral synthesis tool 14, for example, produces the RTL-description circuit 210 as shown in FIG. 9 on the basis of the program 12 as shown in FIG. 8. If the program 12 has the target arithmetic operation 20 adding the directive 202, the behavioral synthesis tool 14 produces the circuit 210 so that the circuit 210 is provided with a bit width detector 212 corresponding to the target arithmetic operation 20. In addition, the tool 14 may produce the circuit 210 so that the circuit 210 is provided with a status register 214 that stores bit width information 222 which is the detection results of the bit width detector 212.

The bit width detector 212 corresponding to the directive 202 is adapted to detect the maximum bit width on the basis of the value of an output data register 36 of a target arithmetic element 34, and update a corresponding status register 214 on the basis of bit width information 222 which is the detection results.

The status register 214 corresponding to the directive 202 is adapted to hold the bit length of the output data register 36 of the target arithmetic element 34. The register 214 also holds an identification number for identifying the target arithmetic element 34. This status register 214 updates a value in accordance with the bit width information 222 obtained by the bit width detector 212. For example, when the bit width information 222 is greater than the current value held in the register 214, the register 214 updates the current value to the value of the bit width information 222. The register 214 may hold an initial value of the bit length of the output data register 36 of the target arithmetic element 34 beforehand.

The behavioral synthesis tool 14 is also adapted to optimize the bit width of the target arithmetic operation 20 on the basis of the bit width information 224 of the operation verification results 122 obtained by the simulator 16. In the case of the first behavioral synthesis, the behavioral synthesis 14 may set a predetermined initial value as the bit width of the target arithmetic operation 20.

The simulator 16 may determine the operation verification results 122 by employing the bit width information 224 in the status register 214 produced in correspondence with the directive.

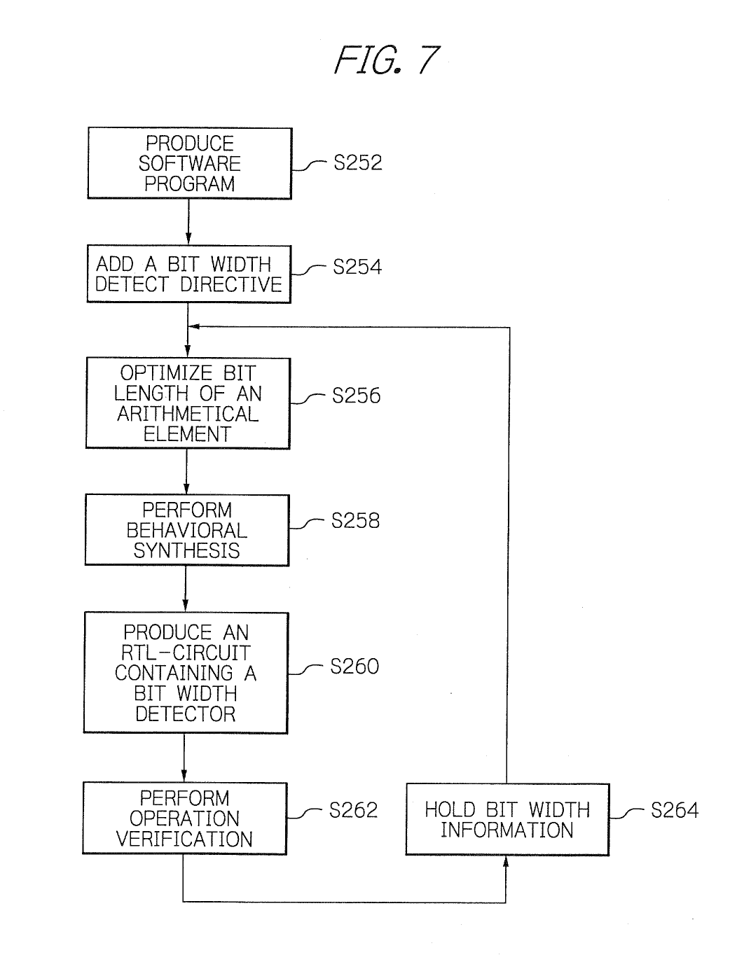

Now, the operation of the circuit designing method of the alternative embodiment will be described with reference to a flowchart shown in FIG. 7 as an example of optimizing the output bit length of an arithmetic element by the detection of a bit width.

In the alternative embodiment, the user, in the same manner as the above illustrative embodiment, produces a software program 12 in step S252, and particularly adds a directive in advance to an arithmetic operation to which a bit width detection function is added (S254).

For instance, as shown in FIG. 8, in the case where a target arithmetic operation 20 whose bit width should be determined calculates an expression “C=A+B”, a code “//alu_plus_detect_range” is added as the directive 202 to the target arithmetic operation 20.

Next, the user, in the same manner as the above illustrative embodiment, initiates the behavioral synthesis of the software program 12 with the behavioral synthesis tool 14. In step S256, the output bit length of each arithmetic element in the program 12 is optimized. Since this stage is the first behavioral synthesis, the output of each arithmetic element is set at a predetermined initial bit length.

In the behavioral synthesis tool 14, in step S258, behavioral synthesis is executed on the basis of the software program 12. In step S260, an RTL-description circuit 210 is produced by employing the bit length determined in step S256 so as to be provided with arithmetic elements corresponding to arithmetic operations in the program 12.

Particularly, when the directive 202 is read from the program 12, in correspondence with the target arithmetic operation 20 to which the directive 202 was added, the bit width detector 212 and status register 214 are added to the circuit 210. For instance, as shown in FIG. 9, the bit width detector 212 and status register 214 are connected to the register 36 that holds the arithmetic operation results of the target arithmetic element 34. Thus, the RTL-description circuit 210 is produced.

Moreover, the user, in the same manner as the above illustrative embodiment, executes the operation verification of the RTL-description circuit 210 produced with the behavioral synthesis tool 14, by the simulator 16, in step S262.

In this operation verification, the bit width detector 38 produced in correspondence with the directive 202 in the RTL-description circuit 210 detects the maximum bit width of the value of the output data register 214 of the target arithmetic element 34 that varies, and updates the status register 214 on the basis of the bit width information 222.

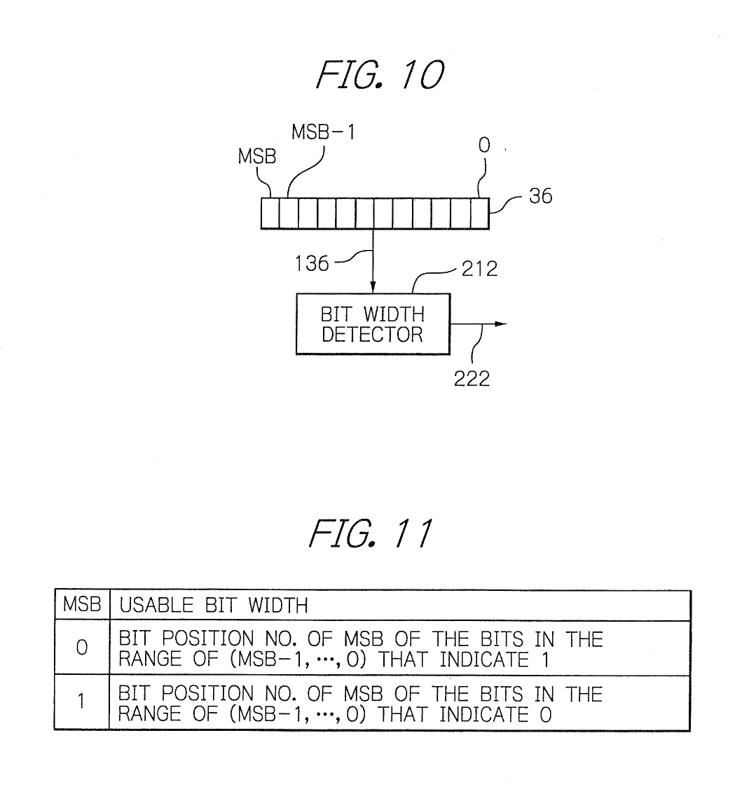

For example, as shown in FIG. 10, the most significant bit of the register 36 is similarly denoted by “MSB”, the second most significant bit by “MSB-1”, and the least significant bit by “0”. At this time, the bit width detector 212 determines the usable bit width of the output register 36. As shown in FIG. 11, when the value of the most significant bit MSB of the register 36 is “0”, i.e. when the register 36 indicates a positive value, the bit width detector 212 determines as a usable bit width the bit position number of the most significant bit indicating “1” among the bits (MSB-1) to 0, and feeds it to the status register 214 as bit width information 222.

Likewise, when the value of the most significant bit MSB of the register 36 is “1”, i.e. when the register 36 indicates a negative value, the bit width detector 38 determines as a usable bit width the bit position number of the most significant bit indicating “0” among the bits (MSB-1) to 0, and feeds it to the status register 214 as bit width information 222.

When the bit width 222 fed from the bit width detector 212 is greater than the current value, the state register 214 holds this bit width 222 to update the current bit width.

Thus, the user can produce and hold the operation verification results 122 such as the bit width information 222 of the RTL-description circuit 210 obtained by the simulator 16 (S264).

When the operation verification results 122, i.e. the bit width information 224 of the status register 214, obtained in step S264 is updated, the user returns to step S256 and is able to use the verification results 122 to again perform the behavioral synthesis of the software program 12 with the behavioral synthesis tool 14.

At this stage, in the behavioral synthesis tool 14, the optimization of the bit length of the output of each arithmetic element is performed (S256), and, particularly on the basis of the bit width information 224, the output bit length of the arithmetic element 34 can be enlarged.

In this way, the user repeats steps S256 to S264 until the operation verification results 122 are obtained without updating a bit width, and then terminates the circuit designing flow. Because the RTL-description circuit 210 obtained at that termination time is constituted by arithmetic elements that do not update a bit width, the user is able to obtain the optimized RTL-description circuit 210. In addition, the user, if removing the directive from the software program 12, is able to produce a final circuit without adding an extra bit width detector.

The behavioral synthesis tool 14 may use the debugging function of software to obtain bit width information, instead of producing the status register 40. In this case, the bit width information is standard-output as the operation verification results obtained in simulation, whereby the output can be employed in the optimization of the bit width of an arithmetic element.

Thus, in the RTL-description circuit designed by the circuit designing method of the present invention, the output bit length of each arithmetic element is optimized. Therefore, in an integrated circuit fabricated by means of the RTL-description circuit, circuit minimization and low power consumption can be greatly achieved compared with conventional integrated circuits.

In accordance with an aspect of the present invention, there is provided an integrated circuit which is designed by a circuit designing flow for producing an RTL-description circuit on a basis of a program sequence defining a desired digital signal processing, and which is fabricated by employing an optimized RTL-description circuit, wherein, in said circuit designing flow, when using the program sequence in which a directive is added to target one of a plurality of arithmetic operations contained in the program sequence, the target arithmetic operation providing an overflow determination of an arithmetic operation result, and performing behavioral synthesis on the basis of at least the program sequence to describe at register transfer level (RTL) a circuit for implementing the desired digital signal processing, said RTL-description circuit is produced so that a detector for detecting information about an output bit length is added to the target arithmetic operation; when operation verification of said RTL-description circuit is performed to obtain a detection result of said detector as a result of the operation verification, and it is determined on the basis of the operation verification result that said RTL-description circuit should be optimized, said RTL-description circuit is again produced so that the output bit length of the target arithmetical operation is optimized on the basis of the detection result; and said optimized RTL-description circuit is obtained by repetitively producing said RTL-description circuit until the output bit length of each of the arithmetic operations is optimized.

In accordance with another aspect of the invention, there is provided a behavioral synthesis tool for producing an RTL-description circuit by performing behavioral synthesis on a basis of a program sequence defining desired digital signal processing, wherein the program sequence is input in which a directive is added to target one of a plurality of arithmetic operations contained in the program sequence, the target arithmetic operation providing an overflow determination of an arithmetic operation result, said tool comprising: a decider for deciding an output bit length of each of the arithmetic operations; and a circuit producer for describing a circuit for implementing the desired digital signal processing on the basis of the program sequence and the output bit length at register transfer level, then adding to the target arithmetic operation a detector for detecting information about the output bit length, and thereby producing said RTL-description circuit; after an operation verification result of said RTL-description circuit is obtained, when it is determined on the basis of the operation verification result that said RTL-description circuit should be optimized, said decider and said circuit producer are executed again, and, when said circuit producer produces said RTL-description circuit for a first time, said decider decides a predetermined initial value as the output bit length, and wherein, when said producer produces said RTL-description circuit in a second loop and a subsequent loop, said decider obtains, as the operation verification result, a detection result of said detector of said RTL-description circuit produced last, and decides an output bit length of each of the arithmetic operations by optimizing the output bit length on the basis of the detection result.

The entire disclosure of Japanese patent application No. 2007-212832 filed on Aug. 17, 2007, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A method for designing a circuit having arithmetic elements that are employed in digital signal processing, comprising:
a program production step of producing a program sequence defining desired digital signal processing;
an addition step of adding a directive to target one of a plurality of arithmetic operations, contained in the program sequence, the target arithmetic operation providing overflow determination of an arithmetic operation result;
a decision step of deciding an output bit length of each of the arithmetic operations;
a circuit production step of performing behavioral synthesis on a basis of the program sequence and the output bit length, describing at register transfer level (RTL) a circuit for implementing the desired digital signal processing, and producing an RTL-description circuit so that a detector for detecting information about the output bit length is added to the circuit in correspondence with the target arithmetic operation; and
a verification step of performing operation verification of the RTL-description circuit to obtain a detection result of the detector as a result of the operation verification;
said decision step and said circuit production step being repeated after said verification step when it is determined on the basis of the operation verification result that the RTL-description circuit should be optimized,
said decision step deciding a predetermined initial value as the output bit length when said circuit production step produces the RTL-description circuit for a first time,
said decision step deciding an output bit length of each of the arithmetic operations by optimizing the output bit length on the basis of detection result about the RTL-description circuit produced last when said circuit production step produces the RTL-description circuit in a second loop and a subsequent loop.

2. The method in accordance with claim 1, wherein
said addition step, in order to add an overflow detector corresponding to the target arithmetic operation, adds as the directive an overflow detecting directive to the program sequence,
said circuit production step, in correspondence with the target arithmetic operation, adds as the detector an overflow detector for detecting overflow information of the output bit length,
said verification step obtains as the detection result the overflow information detected by the overflow detector, and
when said circuit production step produces the RTL-description circuit in the second loop and the subsequent loop, said decision step decides an output bit length of each of the arithmetic operations by optimizing the output bit length on the basis of the overflow information about the RTL-description circuit produced last.

3. The method in accordance with claim 2, wherein
said addition step sets a range of the overflow to add the overflow detecting directive to the program sequence,
said verification step causes the overflow detector, on the basis of a more significant bit, corresponding to the overflow range, of the arithmetic operation result of the target arithmetic operation, to determine whether or not the arithmetic operation result overflow, and obtains a result of the determination as the overflow information, and
after said verification step, when the overflow information indicates overflow, said design method determines that the RTL-description circuit should be optimized, and repeats said decision step and said circuit production step, and, otherwise, said design method ends.

4. The method in accordance with claim 1, wherein
said addition step, in order to add a bit width detector corresponding to the target arithmetic operation, adds as the directive a bit width detecting directive to the program sequence,
said circuit production step, in correspondence with the target arithmetic operation, adds as the detector a bit width detector for detecting bit width information of the output bit width,
said verification step obtains as the detection result the bit width information detected by the bit width detector, and
when said circuit production step produces the RTL-description circuit in the second loop and the subsequent loop, said decision step decides an output bit length of each of the arithmetic operations by optimizing the output bit length on the basis of the bit width information about the RTL-description circuit produced last.

5. The method in accordance with claim 4, wherein
when a most significant bit of the arithmetic operation result of the target arithmetic operation is binary “0”, said verification step causes the bit width detector to determine as a usable bit width a bit position number of the most significant bit indicating binary “1” among remaining bits, and when the most significant bit of the arithmetic operation result of the target arithmetic operation is binary “1”, said verification step causes the bit width detector to determine as the usable bit width the bit position number of the most significant bit indicating binary “0” among the remaining bits,
the usable bit width is employed as the bit width information, and
when the bit width information is greater than a value already set to the target arithmetic operation, said method determines that the RTL-description circuit should be optimized, and repeats said decision step and said circuit production step, and, otherwise, said method ends.

6. The method in accordance with claim 1, wherein
said circuit production step adds to the detector a status register that holds the detection result of the detector in correspondence with the target arithmetic operation,
said verification step stores the detection result in the status register, and
when said circuit production step produces the RTL-description circuit in the second loop and the subsequent loop, said decision step obtains from the status register the detection result about the RTL-description circuit produced last, and decides an output bit length of each of the arithmetic operations by optimizing the output bit length on the basis of the detection result.

7. The method in accordance with claim 1, wherein
said verification step has a debugging function to standard-output the detection result, and
when said circuit production step produces the RTL-description circuit in the second loop and the subsequent loop, said decision step obtains from the standard output the detection result about the RTL-description circuit produced last, and decides an output bit length of each of the arithmetic operations by optimizing the output bit length on the basis of the detection result.

8. The method in accordance with claim 1, wherein
said circuit production step produces the RTL-description circuit so that an interrupt signal is output from the status register,
said verification step stores the detection result in the status register, and
when said circuit production step produces the RTL-description circuit in the second loop and the subsequent loop, said decision step obtains by the interrupt signal the detection result about the RTL-description circuit produced last, and decides an output bit length of each of the arithmetic operations by optimizing the output bit length on the basis of the detection result.

9. The method in accordance with claim 1, wherein
when said circuit production step produces the RTL-description circuit by incorporating a second detector into the RTL-description circuit regardless of the directive, said verification step obtains s second detection result from the second detector, and
when said circuit production step produces the RTL-description circuit in the second loop and the subsequent loop, said decision step decides an output bit length of each of the arithmetic operations by optimizing the output bit length on the basis of the detection result and the second detection result.

10. The method in accordance with claim 1, wherein said verification step performs operation verification of the RTL-description circuit by a simulator.

11. The method in accordance with claim 1, wherein said verification step writes the RTL-description circuit into a programmable logic circuit such as FPGA (Field Programmable Gate Array) to perform operation verification of the logic circuit.

12. The method in accordance with claim 1, wherein, when it is not determined by the operation verification result that the RTL-description circuit needs to be optimized, said decision step and said circuit production step are executed with the directive removed from the program sequence so that the detector is removed from the RTL-description circuit.
